(19) United States
(12) Patent Application Publication
(10) Pub. No.: US 2026/0087488 A1
(43) Pub. Date: Mar. 26, 2026

(54) SECURITY NON-FUNGIBLE TOKENS (NFTs)

(71) Applicant: American Express Travel Related Services Company, Inc., New York, NY (US)

(72) Inventors: John Thomas Hancock, III, Deerfield Beach, FL (US); Hiranmayi PALANKI, Tampa, FL (US)

(21) Appl. No.: 18/893,539

(22) Filed: Sep. 23, 2024

(51) Int. Cl. G06Q 20/36

(52) U.S. Cl. CPC G06Q 20/3672; G06Q 20/3674

(57) ABSTRACT

Disclosed are various embodiments for creating security non-fungible tokens (NFTs) that provide security hardening to NFT wallets used to collect or store collectable NFTs. In response to a request to add a collectable NFT to a user wallet, security NFTs can be created. A security NFT can include a fraud NFT, an access NFT, and a customer service NFT. A fraud NFT is linked to the collectable NFT and can be used to detect fraud. An access NFT and a customer service NFT can be used to permit access to the user wallet.

### BACKGROUND

Distributed ledgers, such as blockchains, offer a number of benefits to their users. For example, data stored in a blockchain is immutable and eventually consistent. In some implementations, executable code, often referred to as a smart contract, can be stored on the blockchain. Parties can request that the nodes of the blockchain execute these smart contracts on their behalf.

A non-fungible token (NFT) is a unique digital identifier that is recorded on a distributed ledger and can be used to certify authenticity and ownership of a given digital or real asset (e.g., artwork, recordings, digital images, etc.). NFTs owned by a given user can be associated with an NFT crypto wallet of the user. Therefore, the user can track ownership of his or her various NFTs via the NFT crypto wallet.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a network environment according to various embodiments of the present disclosure.

FIG. 1B is a drawing of an expanded view of the security distributed ledger within the network environment of FIG. 1A.

FIG. 2 is a sequence diagram illustrating an example of functionality implemented as a portion of the network environment of FIG. 1A according to various embodiments of the present disclosure. In particular, FIG. 1A illustrates an example of the functionality associated with the creation of fraud and access security non-fungible tokens (NFT) according to various embodiments of the present disclosure.

FIG. 3 is a sequence diagram illustrating an example of functionality implemented as a portion of the network environment of FIG. 1A according to various embodiments of the present disclosure. In particular, FIG. 1A illustrates an example of the functionality associated with the creation of customer service security non-fungible tokens (NFT) according to various embodiments of the present disclosure.

FIG. 4 is a flowchart illustrating one example of functionality implemented as portions of an application executed in a quantum computing environment in the network environment of FIG. 1A according to various embodiments of the present disclosure.

### DETAILED DESCRIPTION

Disclosed are various approaches for creating security non-fungible tokens (NFTs) that provide security hardening to NFT wallets used to collect or store collectable NFTs. A collectable NFT is a unique digital asset that is recorded on a distributed ledger and can be used to represent authenticity and ownership of a given digital or real asset (e.g., artwork, recordings, digital images, etc.). In various examples, a user can store his or her collectable NFTs in an NFT wallet. However, NFT wallets can pose an increased risk of payment fraud necessitating an implementation of robust security controls that do not disrupt the customer engagement mode, reduce transaction friction, and promote increased monetization. In various examples, the security NFTs of the present disclosure can be configured to manage access to the user wallet as well as provide a means for identifying fraud (e.g., theft of a collectable NFT) thereby providing security controls for an NFT wallet.

According to various embodiments, a security NFT can comprise a fraud NFT, an access NFT, a customer service NFT, and/or other type of security NFT that can be used to strengthen the security of a user's NFT wallet and/or the user's collectable NFTs. A fraud NFT is associated with a fraud NFT smart contract that is generated specifically for protecting a collectable NFT of a user. An access NFT corresponds to a token that is issued to give access to the wallet. The customer service NFT comprises a temporary NFT that can be issued to a customer service representative or other third-party to provide temporary access to the user wallet. In various examples, the security NFT smart contracts associated with the security NFTs can be stored in a private security distributed ledger and in association with the user wallet identifier or wallet address.

In various examples, a fraud NFT corresponds to a security NFT that is associated with a given collectable NFT that is owned by the user. A fraud NFT can be generated in response to a request by a user to add a collectable NFT to the user's NFT wallet. For example, a fraud NFT smart contract associated with the fraud NFT can be generated in response to a request from the user to store a given collectable NFT in the user's NFT wallet. The fraud NFT smart contract can be generated to check various conditions associated with the collectable NFT and can be associated with a collectable NFT identifier and a collectable NFT smart contract address of the given collectable NFT. The fraud NFT can comprise a user wallet address, a wallet identifier, a fraud NFT identifier, a collectible NFT tuple (e.g., collectable NFT identifier, collectable NFT smart contract wallet address) linking the fraud NFT with the collectable NFT, and/or other types of data.

According to various embodiments, fraud on the collectable NFT can be detected in response to a comparison of the source code of the fraud NFT smart contract with the source code of known compromised fraud NFT smart contracts. For example, a similarity score can be computed based at least in part on the comparison of the source codes. In some examples, if the similarity score is within a given threshold similarity range, the collectable NFT can be determined to be compromised. In some examples, the similarity score calculation can be done using quantum computing based at least in part on Grover's algorithm and Tree Edit Distance (TED). Determining that the fraud NFT smart contract source code is similar to that of known compromised fraud NFT smart contracts can be helpful in providing security and detecting fraud with respect to transactions associated with the collectable NFT. In this case, a potential purchaser of a collectable NFT can ensure that the purchasable asset is not compromised prior to engaging in the transaction to purchase the asset.

In various examples, an access NFT corresponds to a security NFT that can be issued to provide secure access to the user wallet. In some examples, the access NFT can be generated and minted when a user creates an NFT wallet. In other examples, an access NFT can be generated in response to a request to add a collectable NFT to the user wallet. In various examples, the access NFT can be generated following a process in which the user's identity is verified and authenticated. In some examples, generating the access NFT comprises generating an access NFT smart contract that governs the access of a given user wallet. In other examples, an access NFT can be created by invoking a mint function associated with an already existing access NFT smart contract. In various examples, the access NFT can comprise a user wallet address, a wallet identifier, access NFT permissions, an access NFT identifier, verification data, and/or other types of data that can be used to securely provide access to the user wallet.

Similar to the access NFT, the customer service NFT corresponds to a security NFT that can be issued to provide secure access to the user wallet. Unlike the access NFT, the customer service NFT is issued to a customer service representative or other third party that is permitted by the user to temporarily access the user wallet. For example, on a report of fraud associated with a collectable NFT or, more broadly, the user NFT wallet, a customer service representative can assist the user with locking, or otherwise restricting access to, the NFT wallet or the given collectable NFT. However, prior to assisting the user, the customer service representative will need to be issued a security NFT that permits access to the user wallet. In various examples, the customer service NFT can be linked to an already issued access NFT. The customer service NFT can comprise a customer service NFT identifier, a user wallet address, customer service NFT permissions, an access NFT smart contract wallet address, a wallet identifier, and/or other types of data that can be used to securely provide access to the user wallet.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

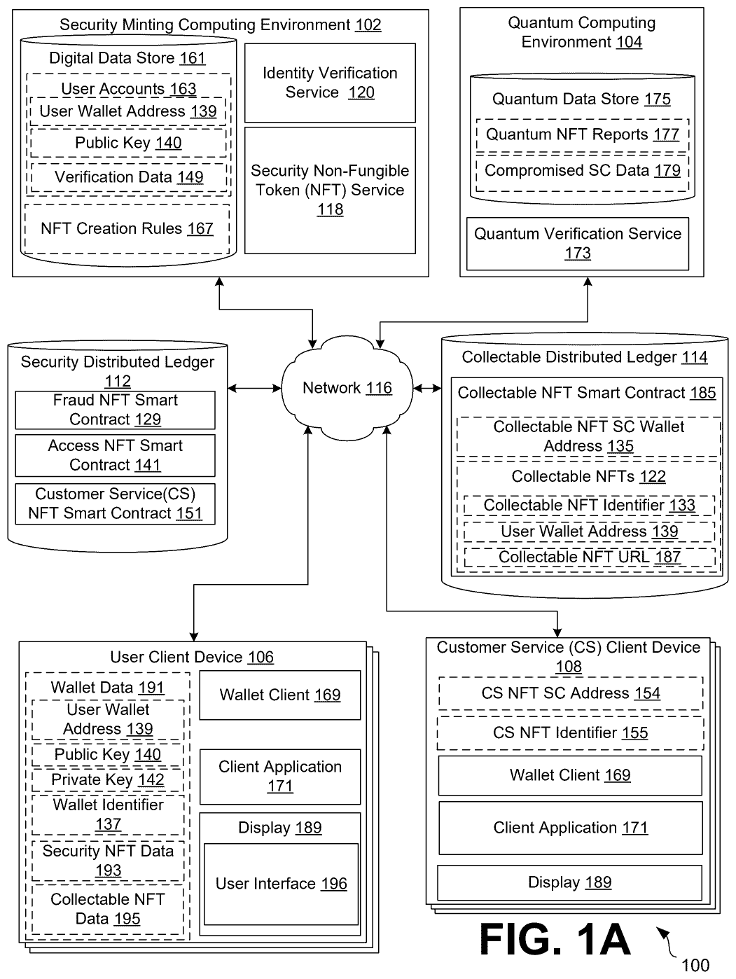

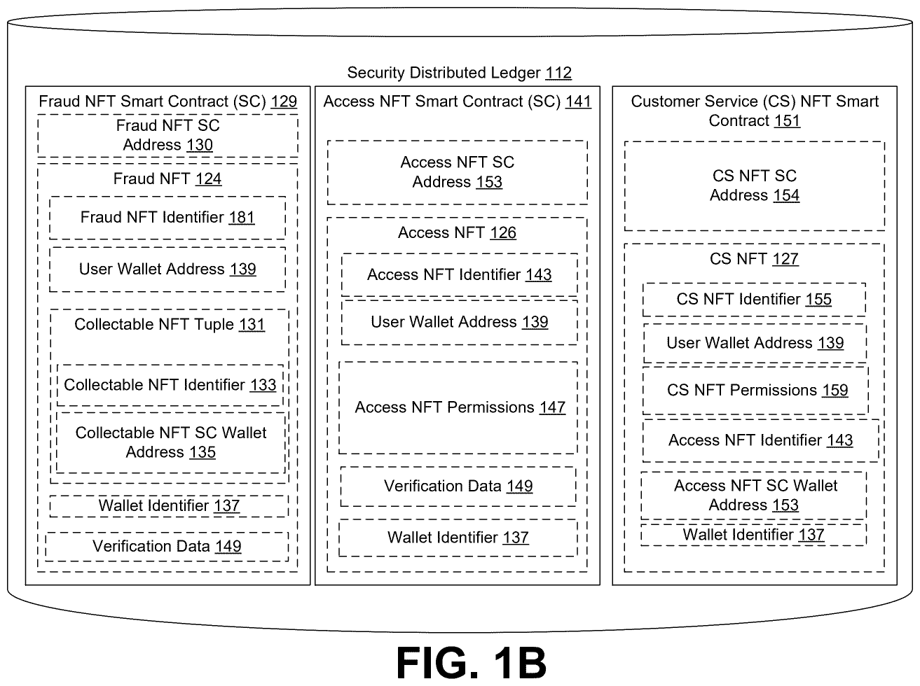

With reference to FIG. 1A, shown is a network environment 100 according to various embodiments. The network environment 100 can include a security minting computing environment 102, a quantum computing environment 104, a user client device 106, a customer service client device 108, a security distributed ledger 112, and a collectable distributed ledger 114, which can be in data communication with each other via a network 116. It should be noted that although the security minting computing environment 102 and the quantum computing environment 104 are illustrated as being separate computing environments, in some examples, at least some of functionality of the security minting computing environment 102 can be included in the quantum computing environment 104. In other examples, at least some of the functionality of the quantum computing environment 104 can be included in the security minting computing environment 102.

The network 116 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 116 can also include a combination of two or more networks 116. Examples of networks 116 can include the Internet, intranets, extranets, virtual private networks (VPNs), and similar networks.

The security minting computing environment 102 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the security minting computing environment 102 can employ a plurality of computing devices that can be arranged in one or more server banks or computer banks or other arrangements. Such computing devices can be located in a single installation or can be distributed among many different geographical locations. For example, the security minting computing environment 102 can include a plurality of computing devices that together can include a hosted computing resource, a grid computing resource or any other distributed computing arrangement. In some cases, security minting computing environment 102 can correspond to an elastic computing resource where the allotted capacity of processing, network, storage, or other computing-related resources can vary over time.

Various applications or other functionality can be executed in the security minting computing environment 102. The components executed on the security minting computing environment 102 include a security NFT service 118, an identity verification service 120, and other applications, services, processes, systems, engines, or functionality not discussed in detail herein.

The security NFT service 118 can be executed to generate and issue security NFTs for securing access to a user's NFT wallet as well as detecting fraud of a collectable NFT 122. For example, the security NFT service 118 can create and issue a fraud NFT(s) 124 (FIG. 1B), an access NFT(s) 126 (FIG. 1B), a customer service NFT(s) 128 (FIG. 1B), and/or other types of security NFTs that can be used to protect a user and the user's NFT wallet.

In various examples, the security NFT service 118 can interact with a user client device 106 and receive a request to add a collectable NFT 122 to a user wallet. In response to receiving the request to add the collectable NFT 122 to the user wallet, the security NFT service 118 can verify the identity of the user. In some examples, the security NFT service 118 can interact with the identity verification service 120 and/or a third-party service to verify the identity of the user. In various examples, the identity of the user can be verified in accordance to identity verification standards (e.g., Know Your Customer (KYC), anti-money laundering (AML), etc.) to ensure the identity verification is compliant.

The security NFT service 118 can create a fraud NFT 124 by generating a fraud NFT smart contract 129. A smart contract can represent executable computer code that can be executed by a node of a distributed ledger (e.g., blockchain). In many implementations, the smart contract can expose one or more functions that can be called by any user or by a limited set of users. To execute one or more functions of a smart contract, an application can submit a request to a node of the distributed to execute the function. The node can then execute the function and store the result to the distributed ledger.

The security NFT service 118 can create the fraud NFT smart contract 129 to generate the fraud NFT 124 for a given collectable NFT 122. In various examples, the fraud NFT smart contract 129 is generated in compliance with ERC-721, ERC-1125, or similar standards for implementing smart contracts for NFTs. In various examples, the fraud NFT smart contract 129 can check various conditions (e.g., ownership, wallet identifier, etc.) associated with the collectable NFT 122. In various examples, the security NFT service 118 can write the fraud NFT smart contract 129 to the security distributed ledger 112. The fraud NFT smart contract 129 can then be accessed via the fraud NFT smart contract address 130. In some examples, the security NFT service 118 can mint a fraud NFT 124 by invoking the mint function of the fraud NFT smart contract 129 stored in the security distributed ledger 112. To link the fraud NFT 124 with the collectable NFT 122, the fraud NFT 124 can comprise a collectible NFT tuple 131 which can include a collectable NFT identifier 133 and a collectable NFT smart contract address 135 of the given collectable NFT 122. In addition, the security NFT service 118 can store the fraud NFT 124 in the user wallet by associating the fraud NFT 124 with a wallet identifier 137, user wallet address 139, and/or other type of wallet associator in the fraud NFT 124.

The security NFT service 118 can also generate an access NFT 126 to securely permit access to the NFT wallet of the user. Prior to generating the access NFT 126, the security NFT service 118 can authenticate the user. For example, the user client device 106 associated with the requesting user can provide an authentication token or other form of authentication that can be validated. In other examples, the security NFT service 118 can authenticate the user by generating a cryptographic challenge and sending the cryptographic challenge to the user client device 106 associated with the user and the user wallet address 139. The user client device 106 can return the cryptographic challenge signed with the private key 142 associated with the user wallet address 139. In some examples, the user client device 106 obtains access to the private key 142 in response to the user providing a passcode to unlock the private key 142 for use in signing the cryptographic challenge. Upon receiving the signed cryptographic challenge and confirming that the public key 140 associated with the user wallet address 139 decrypts the signed cryptographic challenge, the security NFT service 118 can assert that the verified user controls the private key 142 associated with the user wallet address 139 and thereby controls the user wallet address 139. Once the user has been authenticated to show ownership of the given user NFT wallet, the security NFT service 118 can generate an access NFT 126.

In some examples, the security NFT service 118 can generate an access NFT smart contract 141 which can be invoked to create an access NFT 126. In various examples, the access NFT smart contract 141 is generated in compliance with ERC-721, ERC-1125, or similar standards for implementing smart contracts for NFTs. The security NFT service 118 can write the access NFT smart contract 141 to the security distributed ledger 112. The access NFT smart contract 141 can then be accessed via the access NFT smart contract address 153.

In some examples, the security NFT service 118 can invoke a mint function associated with the access NFT smart contract 141 stored in the security distributed ledger 112. In various examples, the mint function call can include the user wallet address 139, wallet identifier 137, and/or other wallet specific data that can be used to associate the access NFT 126 with the NFT wallet of the user. In some examples, the access NFT 126 can further be created to include an access NFT identifier 143, access NFT permissions 147, verification data 149, and/or other data.

In various examples, the security NFT service 118 can generate a customer service NFT 127 that can provide a customer service client device 108 or other third-party client device temporary access to the user's NFT wallet. In this example, the security NFT service 118 can interact with a customer service client device 108 and receive a request for a customer service NFT 127 for access to a user wallet. Upon receiving the request from the customer service client device 108, the security NFT service 118 can verify that the user is permitting the customer service client device 108 with access to the user's NFT wallet.

In some examples, the security NFT service 118 can generate a customer service NFT smart contract 151 which can be invoked to create a customer service NFT 127. In various examples, the customer service NFT smart contract 151 is generated in compliance with ERC-721, ERC-1125, or similar standards for implementing smart contracts for NFTs. The security NFT service 118 can write the customer service NFT smart contract 151 to the security distributed ledger 112. The customer service NFT smart contract 151 can then be accessed via the customer service NFT smart contract address 154.

In some examples, the security NFT service 118 can invoke a mint function associated with the customer service NFT smart contract 151 stored in the security distributed ledger 112. In various examples, the mint function call can include the user wallet address 139, wallet identifier 137 and/or other wallet specific data that can be used to associate the customer service NFT 127 with the NFT wallet of the user. Accordingly, the customer service NFT 127 can be generated to include the user wallet address 139, wallet identifier 137 and/or other wallet specific data that can be used to associate the customer service NFT 127 with the NFT wallet of the user. In some examples, the customer service NFT 127 can further be created to be associated with the access NFT 126 by including the access NFT smart contract address 153, the access NFT identifier 143, and/or other component that associates the customer service NFT 127 with the access NFT 126. The customer service NFT 127 can further include a customer service NFT identifier 155, customer service NFT permissions 159, and/or other data.

The identity verification service 120 can be executed to verify an identity of a user associated with a given user wallet address 139. For example, the identity verification service 120 can interact with a user associated with the user client device 106 and request documentation that can be used to verify the identity of the user. For example, the identity verification service 120 can request the user to provide a first image comprising a photograph of the user and a second image of a government issued identification card that includes a photograph of the user. The identity verification service 120 can compare the first image with the second image to verify whether the identity of the user is the same. In various examples, the identity verification service 120 verifies the identity of the user in accordance to identity verification standards (e.g., Know Your Customer (KYC), anti-money laundering (AML), etc.) to ensure the identity verification is compliant. In some examples, the identity verification service 120 can request one or more trusted third-party services that are executed outside of the security minting computing environment 102 to perform the identity verification of the user.

It should be noted that although the security NFT service 118 and the identity verification service 120 are illustrated and discussed as being separate and distinct applications, in some examples, the security NFT service 118 includes some or all of the functionality of the identity verification service 120 and/or the identity verification service 120 includes some or all of the functionality of the security NFT service 118.

Also, various data is stored in a digital data store 161 that is accessible to the security minting computing environment 102. The digital data store 161 can be representative of a plurality of data stores 161, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the digital data store 161 is associated with the operation of the various applications or functional entities described below. This data can include user accounts 163, an issuer identifier 165, NFT validity rules, and potentially other data.

The user account 163 can represent data associated with individual users of a wallet service that helps manage assets stored in a user wallet. Examples of data that could be stored in a user account 163 can include a user wallet address 139, a public key 140, and verification data 149, as well as other data.

The user wallet address 139 can represent a wallet address for distributed ledger (e.g., collectable distributed ledger 114, security distributed ledger 112) for which a user has demonstrated control or ownership. A user account 163 can have multiple user wallet addresses 139 linked to or associated with the user account 163. For example, the user account 163 could have separate user wallet addresses 139 for separate types of distributed ledgers (e.g., an ETHEREUM address, a SOLANA address, a BITCOIN address, etc.) or multiple user wallet addresses 139 for the same distributed ledger (e.g., multiple ETHEREUM addresses).

The public key 140 corresponds to the public key of a public-private key pair controlled by the user and generated by the wallet client 169, client application 171, or another application of the user client device 106. The key-pair can be generated using various approaches, such as elliptic curve cryptography (ECC) approaches or using the Rivest-Shamir-Adleman (RSA) algorithm. The corresponding private key 142 remains stored by the user client device 106 or another type of storage controlled by the user and can be used to sign any cryptographic challenges sent to the wallet client 169 or client application 171 for user verification.

The verification data 149 comprises data associated with the identity verification of the user. For example, the verification data 149 can include one or more user characteristics, a geographic identifier (e.g., country code for user location), the identification of a blockchain associated with a user wallet address 139, a level of identity verification (e.g., indication of which identity verification standards were met, etc.), or other types of data.

The NFT creation rules 167 include rules, models, and/or configuration data for the various algorithms or approaches employed by the security NFT service 118 for generating the various security NFTs (e.g., fraud NFT 124, access NFT 126, customer service NFT 127). For example, the NFT creation rules 167 can define how a fraud NFT smart contract 129 is to be generated and what types of conditions to look for to confirm the relationship between the fraud NFT 124 and the collectable NFT 122. In addition, the NFT creation rules 167 can define the type of verification and authentication required by the user prior to generating the fraud NFT 124 and/or the access NFT 126. In some examples, the NFT creation rules 167 can define the amount of access time that is associated with the access NFT 126 and/or the customer service NFT 127. For example, a customer service NFT 127 could only be valid for a set amount of time that is defined by the NFT creation rules 167 based at least in part on the customer service provider.

The quantum computing environment 104 can include one or more quantum computing devices (e.g., devices configured to process quantum data formatted as “quantum bits” also called “qubits”) that include a quantum processor, a quantum memory, and/or a network interface. The quantum computing devices can be referred to as a “quantum-based” or “qubit-based” computing architecture that performs operations using quantum bits or qubits that can represent multiple states at a given time for information storage and manipulation. The software executed using quantum computing devices can also be referred to as “quantum-based,” or “qubit-based,” and can use qubit-based operations. The qubit can be considered a basic unit of information in quantum computing and quantum communications. The qubit can be maintained based at least in part on the spin of electron or polarization of a photon. The quantum computing devices can be configured to perform quantum computations on behalf of other computing devices (e.g., digital computing devices) or applications (e.g., quantum verification service 173, etc.). In some embodiments, quantum computing devices can host and/or provide content to other computing devices (e.g., digital computing devices or quantum computing devices) in response to requests for content.

The quantum computing environment 104 can also include one or more digital computing devices (e.g., devices configured to process traditional binary and/or bitwise data and process) that include a digital processor, a digital memory, and/or a network interface. For example, the digital computing devices can be configured to perform non-quantum computations on behalf of other digital computing devices or applications. As another example, such digital computing devices can host and/or provide content to other computing devices (e.g., digital computing devices or quantum computing devices) in response to requests for content. As another example, such digital computing devices can request that other computing devices (e.g., digital computing devices or quantum computing devices) provide content in response to a request by the digital computing device. In such an example, the digital computing device can receive the content from the other computing devices (e.g., digital computing devices or quantum computing devices) or from some other source. By having both digital computing devices and quantum computing devices on the quantum computing environment 104, the digital computing devices can act as an intermediary between other computing devices and the quantum computing devices, facilitating the execution of the necessary quantum processing with the quantum computing devices.

Moreover, the quantum computing environment 104 can employ a plurality of digital computing devices and/or quantum computing devices that can be arranged in one or more server banks or computer banks or other arrangements. Such digital computing devices or quantum computing devices can be located in a single installation or can be distributed among many different geographical locations. For example, the quantum computing environment 104 can include a plurality of digital computing devices and/or quantum computing devices that together can include a hosted computing resource, a grid computing resource, or any other distributed computing arrangement. In some cases, the quantum computing environment 104 can correspond to an elastic computing resource, where the allotted capacity of processing, network, storage, or other computing-related resources can vary over time.

Various data can be stored in a quantum data store 175 that is accessible to the quantum computing environment 104. The quantum data store 175 can be representative of a plurality of quantum data stores 175, which can include relational databases or non-relational databases, such as object-oriented databases, hierarchical databases, hash tables, or similar key-value data stores, as well as other data storage applications, or data structures. Moreover, combinations of these databases, data storage applications, and/or data structures can be used together to provide a single, logical, data store. In various embodiments, the data stored in the quantum data store 175 can be structured as digital bits, representing how a qubit can be configured to represent the data. In other various embodiments, the data stored in the quantum data store 175 can store the data as a quantum state for easy retrieval by the quantum computing device. By storing the data as a quantum state, portions of the data can be stored in a quantum superposition, representing one or more possible states of the data. The data stored in the quantum data store 175 is associated with the operation of the various applications or functional entities described below. This data can include a quantum NFT reports 177, compromised smart contract (SC) data 179, and potentially other data.

The quantum NFT reports 177 can include a listing of NFTs (e.g., collectable NFTs 122, fraud NFT 124, access NFT 126, customer service NFT 127, etc.) that have been reported as being compromised or otherwise fraudulent. For example, the quantum NFT reports 177 can include a fraud NFT identifier 181, access NFT identifier 143, customer service NFT identifier 155, collectable NFT identifier 133, and/or other type of identifier that can be used to identify a given NFT. In some examples, the identifier can comprise a smart contract address (e.g., collectable NFT smart contract wallet address 135, fraud NFT smart contract address 130, access NFT smart contract address 153, customer service NFT smart contract address 154, etc.) associated with the security NFT and/or collectable NFT 122. In various examples, the quantum NFT reports 177 can be converted from a digital representation to a quantum representation for processing by a quantum computing device.

The compromised smart contract data 179 can represent a quantum state representations of security NFT smart contracts associated with a compromised NFTs that have been reported as being compromised or otherwise fraudulent. For example, a fraud NFT smart contract 129 associated with a collectable NFT 122 that is determined to be compromised can be converted to an abstract tree representation which can then be converted to quantum bits for processing by a quantum computing device. In various examples, when determining whether a given collectable NFT 122 is compromised, the quantum verification service 173 can compare a quantum representation of a fraud NFT smart contract 129 with the compromised smart contract data 179 to determine the similarity between the different smart contracts. If the similarity score is within a given similarity range, the quantum verification service 173 can determine that the collectable NFT 122 is compromised. In some examples, the similarity score calculation can be done using quantum computing based at least in part on Grover's algorithm and Tree Edit Distance (TED).

Various applications or other functionality can be executed in the quantum computing environment 104. The components executed on the quantum computing environment 104 include a quantum verification service 173, and other applications, services, processes, systems, engines, or functionality not discussed in detail herein.

The quantum verification service 173 can be executed to verify whether a given NFT (security NFT, collectable NFT 122, etc.) is valid. In some examples, the quantum verification service 173 can receive a request to verify whether a given NFT (security NFT, collectable NFT 122, etc.) is valid. In some examples, the quantum verification service 173 can review the quantum NFT reports 177 to determine if a collectable NFT 122 or related security NFT has been reported as being compromised. For example, if the quantum NFT reports 177 includes the collectable NFT identifier 133 of the collectable NFT 122 of interest, the quantum verification service 173 can respond that the given NFT is invalid or otherwise compromised.

In other examples, if the quantum NFT reports 177 does not include an identifier associated with the given NFT, the quantum verification service 173 can obtain the source code associated with the security smart contract. For example, the quantum verification service 173 can obtain the source code associated with the fraud NFT smart contract 129. The source code can be obtained by accessing the fraud NFT smart contract 129 via the fraud NFT smart contract address 130. Upon obtaining the source code, the quantum verification service 173 can convert the source code to an abstract syntax tree based on the various conditions of the fraud NFT smart contract 129. Upon converting the source code to the abstract syntax tree, the quantum verification service 173 can convert the abstract syntax tree representation into a quantum representation of bits. The quantum verification service 173 can compare a quantum representation of a fraud NFT smart contract 129 with the compromised SC data 179 to determine the similarity between the different smart contracts. If the similarity score is within a given similarity range, the quantum verification service 173 can determine that the collectable NFT 122 is compromised. In some examples, the similarity score calculation can be done using quantum computing based at least in part on Grover's algorithm and Tree Edit Distance (TED).

The security distributed ledger 112 represents a synchronized, eventually consistent, data store spread across multiple nodes, some or all of which can be in different geographic or network locations. A node can be a computer system or device that includes a processor, a memory, a network interface, and various other hardware. Such a computer system can be embodied in the form of a desktop computer, a laptop computer, server computer, or other devices providing computing capability. Each node can contain a replicated copy of the security distributed ledger 112, including all data stored in the security distributed ledger 112.

Records of transactions involving the security distributed ledger 112 can be shared or replicated using a peer-to-peer network connecting the individual nodes that can write to the security distributed ledger 112. Once a transaction or record is recorded in the security distributed ledger 112, it can be replicated across the peer-to-peer network until the record is eventually recorded with all of the nodes. Various consensus methods can be used to ensure that data is written reliably to the security distributed ledger 112. Examples of a distributed ledger can include blockchains, distributed hash tables (DHTs), and similar data structures. In various examples, the security distributed ledger 112 comprises a private distributed ledger on a private network.

Various data can also be stored in the security distributed ledger 112. FIG. 1B illustrates an expanded view of the data included in the security distributed ledger 112. The data can include one or more fraud NFT smart contract(s) 129, one or more access NFT smart contracts 141, one or more customer service (CS) NFT smart contracts 151, and/or other information.

The fraud NFT smart contract 129 can be executed to define the rules and conditions of a fraud NFT 124 and corresponding collectable NFT 122. The fraud NFT smart contract 129 can be used to indicate whether there is fraud on a corresponding collectable NFT 122. A smart contract can represent executable computer code that can be executed by a node of a distributed ledger (e.g., blockchain). In many implementations, the smart contract can expose one or more functions that can be called by any user or by a limited set of users. To execute one or more functions of a smart contract, an application can submit a request to a node of the distributed to execute the function. The node can then execute the function and store the result to the security distributed ledger 112.

In various examples, the fraud NFT smart contract 129 is generated in compliance with ERC-721, ERC-1125, or similar standards for implementing smart contracts for NFTs. In various examples, the fraud NFT smart contract 129 can check various conditions (e.g., ownership, wallet identifier, etc.) associated with the collectable NFT 122. In various examples, the security NFT service 118 can write the fraud NFT smart contract 129 to the security distributed ledger 112. The fraud NFT smart contract 129 can then be accessed via the fraud NFT smart contract address 130. In some examples, the fraud NFT smart contract 129 can mint a fraud NFT 124 by invoking the mint function of the fraud NFT smart contract 129 stored in the security distributed ledger 112.

The fraud NFT 124 comprises a fraud NFT identifier 181, a user wallet address 139, a collectable NFT tuple 131, a wallet identifier 137, verification data 149, and/or other data. The fraud NFT 124 is distinguished from other fraud NFTs 124 minted or maintained by the fraud NFT smart contract 129 through use of the fraud NFT identifier 181. In particular, the fraud NFT identifier 181 uniquely identifies the fraud NFT 124 with respect to other fraud NFTs 124 minted or maintained by the fraud NFT smart contract 129. In various examples, the user wallet address 139 can also uniquely identify the fraud NFT 124 with respect to other fraud NFTs 124 minted or maintained by the fraud NFT smart contract 129.

To link the fraud NFT 124 with the collectable NFT 122, the fraud NFT 124 can comprise a collectible NFT tuple 131 which can include a collectable NFT identifier 133 and a collectable NFT smart contract address 135 of the given collectable NFT 122. In addition, the security NFT service 118 can store the fraud NFT 124 in the user wallet by associating the fraud NFT 124 with a wallet identifier 137, the user wallet address 139, and/or other type of wallet associator in the fraud NFT 124. The wallet identifier 137 can comprise an identifier that is unique to the given user wallet. In some examples, the wallet identifier 137 comprises the user wallet address 139. In other examples, the wallet identifier 137 is different from the user wallet address 139.

The verification data 149 comprises data associated with the identity verification of the user. For example, the verification data 149 can include one or more user characteristics, a geographic identifier (e.g., country code for user location), the identification of a blockchain associated with a user wallet address 139, a level of identity verification (e.g., indication of which identity verification standards were met, etc.), or other types of data.

The access NFT smart contract 141 can be executed to mint and manage an access NFT 126 that can be issued to provide access to a user's NFT wallet. In various examples, the access NFT smart contract 141 is generated in compliance with ERC-721, ERC-1125, or similar standards for implementing smart contracts for NFTs. The security NFT service 118 can write the access NFT smart contract 141 to the security distributed ledger 112. The access NFT smart contract 141 can then be accessed via the access NFT smart contract address 153.

In various examples, the access NFT smart contract 141 can be invoked to mint and/or manage an access NFT 126. A minted access NFT 126 comprises an access NFT identifier 143, a user wallet address 139, access NFT permissions 147, verification data 149, a wallet identifier 137, and/or other data. The access NFT 126 distinguished from other access NFTs 126 minted or maintained by the access NFT smart contract 141 through use of the access NFT identifier 143. In particular, the access NFT identifier 143 uniquely identifies the access NFT 126 with respect to other access NFTs 126 minted or maintained by the access NFT smart contract 141. In various examples, the user wallet address 139 can also uniquely identify the access NFT 126 with respect to other access NFTs 126 minted or maintained by the access NFT smart contract 141.

The access NFT permissions 147 include rules or conditions associated with accessing the linked user wallet. In various examples, the access NFT permissions 147 can include an expiration date. For example, an access NFT 126 can have temporal restrictions associated with the validity of the access NFT. In this example, an access NFT 126 could only be valid during a predefined amount of time, the amount of time of an active session, and/or other type of temporal restriction.

The customer service NFT smart contract 151 can be executed to mint and manage customer service (CS) NFTs 127 that can be issued to provide temporary access to a user's NFT wallet. In various examples, the customer service NFT smart contract 151 is generated in compliance with ERC-721, ERC-1125, or similar standards for implementing smart contracts for NFTs. The customer service NFT smart contract 151 can be written to and stored in the security distributed ledger 112. The customer service NFT smart contract 151 can then be accessed via the customer service NFT smart contract address 153.

In various examples, the customer service NFT smart contract 151 can be invoked to mint and/or manage a customer service NFT 127. A minted customer service NFT 127 comprises a customer service NFT identifier 155, a user wallet address 139, customer service NFT permissions 159, the access NFT smart contract address 153, the access NFT identifier 143, a wallet identifier 137, and/or other data. The customer service NFT 127 is distinguished from other customer service NFTs 127 minted or maintained by the customer service NFT smart contract 151 through use of the customer service NFT identifier 155. In particular, the customer service NFT identifier 155 uniquely identifies the customer service NFT 127 with respect to other customer service NFTs 127 minted or maintained by the customer service NFT smart contract 151. In various examples, the user wallet address 139 can also uniquely identify the customer service NFT 127 with respect to other customer service NFT 127 minted or maintained by the customer service NFT smart contract 151.

The customer service NFT permissions 159 include rules or conditions associated with accessing the linked user wallet. In various examples, the customer service NFT permissions 159 can include an expiration date. For example, a customer service NFT permissions 159 can have temporal restrictions associated with the validity and use of the customer service NFT 127. In this example, the customer service NFT 127 could only be valid during a predefined amount of time, the amount of time of an active session, and/or other type of temporal restriction.

In various examples, the customer service NFT 127 can be linked to an access NFT 126 issued with respect to access to a given user's NFT wallet. In this respect, the customer service NFT 127 can be linked by containing the access NFT smart contract address 153, the access NFT identifier 143, and/or other information associated with an issued access NFT 126.

The collectable distributed ledger 114 represents a synchronized, eventually consistent, data store spread across multiple nodes, some or all of which can be in different geographic or network locations. A node can be a computer system or device that includes a processor, a memory, a network interface, and various other hardware. Such a computer system can be embodied in the form of a desktop computer, a laptop computer, server computer, or other devices providing computing capability. Each node can contain a replicated copy of the collectable distributed ledger 114, including all data stored in the collectable distributed ledger 114.

Records of transactions involving the collectable distributed ledger 114 can be shared or replicated using a peer-to-peer network connecting the individual nodes that can write to the collectable distributed ledger 114. Once a transaction or record is recorded in the collectable distributed ledger 114, it can be replicated across the peer-to-peer network until the record is eventually recorded with all of the nodes. Various consensus methods can be used to ensure that data is written reliably to the collectable distributed ledger 114. Examples of a distributed ledger can include blockchains, distributed hash tables (DHTs), and similar data structures. In various examples, the collectable distributed ledger 114 comprises a private or public distributed ledger on a private or public network.

Various data can also be stored in the collectable distributed ledger 114. The data can include one or more collectable NFT smart contract(s) 185 and/or other information. However, any other data discussed in the present disclosure could also be stored in the collectable distributed ledger 114 if the public availability of the data were acceptable in that particular implementation.

The collectable NFT smart contract 185 can include a collectable NFT smart contract wallet address 135, and the functions provided by the collectable NFT smart contract 185 can be executed to allow users to mint or create collectable NFTs 122 representing ownership of a particular asset owned by a user. In various examples, a collectable NFT 122 is linked to the user wallet address 139, collectable NFT identifier 133, a collectable NFT uniform resource locator (URL) 187, and/or other data. The collectable NFT 122 is distinguished from other collectable NFTs 122 minted or maintained by the collectable NFT smart contract 185 through use of the collectable NFT identifier 133. In particular, the collectable NFT identifier 133 uniquely identifies the collectable NFT 122 with respect to other collectable NFTs 122 minted or maintained by the collectable NFT smart contract 185. In various examples, the user wallet address 139 can also uniquely identify the collectable NFT 122 with respect to other collectable NFT 122 minted or maintained by the collectable NFT smart contract 185.

The collectable NFT URL 187 corresponds to a link or URL associated with the asset that the collectable NFT 122 represents ownership of. For example, the collectable NFT URL 187 can correspond to a URL for accessing a digital asset that is owned by the user as represented by the collectable NFT 122.

Although the security distributed ledger 112 and the collectable distributed ledger 114 as illustrated as being separate and distinct from one another, in some examples, one or more portions of data included in the collectable distributed ledger 114 can be included in the security distributed ledger 112 and vice versa.

The user client device 106 and the customer service client device 108 can each be representative of a plurality of client devices that can be coupled to the network 116. The user client device 106 and the customer service client device 108 can each include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The user client device 106 and the customer service client device 108 can each include one or more displays 189, such as liquid crystal displays (LCDs), gas plasma-based flat panel displays, organic light emitting diode (OLED) displays, electrophoretic ink (“E-ink”) displays, projectors, or other types of display devices. In some instances, the display 189 can be a component of the user client device 106 or the customer service client device 108 or can be connected to the user client device 106 or the customer service client device 108 through a wired or wireless connection.

The user client device 106 and the customer service client device 108 can be configured to execute various applications such as a user wallet client 169, a client application 171 or other applications. The wallet client 169 can be executed to allow the user client device 106 or the customer service client device 108 to interact with the nodes of the security distributed ledger 112, the collectable distributed ledger 114, and/or other types of distributed ledgers or blockchains. The wallet client 169 can be executed to send cryptocurrency assets from the user wallet address 139 to a specified wallet address, to view NFTs that security distributed ledger 112 and/or the collectable distributed ledger 114 have recorded as being associated with the user wallet address 139, or to sign transactions associated with the user wallet address 139 using the private key 157. Examples of wallet clients 169 include METAMASK, EXODUS Wallet, etc.

The client application 171 can be executed in the user client device 106 or the customer service client device 108 to access network content served up by the security minting computing environment 102, the quantum computing environment 104, or other servers, thereby rendering a user interface 196 on the display 189. To this end, the client application 171 can include a browser, a dedicated application, or other executable, and the user interface 196 can include a network page, an application screen, or other user mechanism for obtaining user input. The user client device 106 can be configured to execute applications beyond the client application 171 such as email applications, social networking applications, word processors, spreadsheets, or other applications.

It should be noted that although the client application 171 and the wallet client 169 are illustrated and discussed as being separate and distinct applications, in some examples, the client application 171 includes some or all of the functionality of the wallet client 169 and/or the wallet client 169 includes some or all of the functionality of the client application 171.

Various data can also be stored on the customer service client device 108, such as a customer service smart contract address 154, a customer service NFT identifier 155, and potentially other data. Various data can also be stored on the user client device 106, such as wallet data 191, and potentially other data. The wallet data 191 can include a user wallet address 139, a public key 140, a private key 142, a wallet identifier 137, security NFT data 193, collectable NFT data 195, and potentially other data.

The user wallet address 139 can represent a wallet address for a NFT wallet on a distributed ledger for which a user has demonstrated control or ownership. In various examples, one or more separate user wallet addresses 139 for separate distributed ledgers (e.g., an ETHEREUM address, a SOLANA address, a BITCOIN address, etc.) or multiple user wallet addresses 139 for the same distributed ledger (e.g., multiple ETHEREUM addresses).

The public key 140 corresponds to the public key of a public-private key pair controlled by the user and generated by the wallet client 169, client application 171, or another application of the user client device 106. The key-pair can be generated using various approaches, such as elliptic curve cryptography (ECC) approaches or using the Rivest-Shamir-Adleman (RSA) algorithm. The corresponding private key 142 remains stored by the user client device 106 or another type of storage controlled by the user and can be used to sign any cryptographic challenges sent to the wallet client 169 or client application 171 for user verification.

The security NFT data 193 can include data associated with one or more security NFTs issued to the user and associated with the user NFT wallet. For example, the security NFT data 193 can include one or more fraud NFT identifiers 181 and/or corresponding fraud NFT smart contract addresses 130, one or more access NFT identifiers 143 and/or corresponding access NFT smart contract addresses 153, and/or other data. The collectable NFT data 195 can include data associated with one or more collectable NFTs 122 that are associated with the user NFT wallet. For example, the collectable NFT data 195 can include one or more collectable NFT identifiers 133 and/or other data.

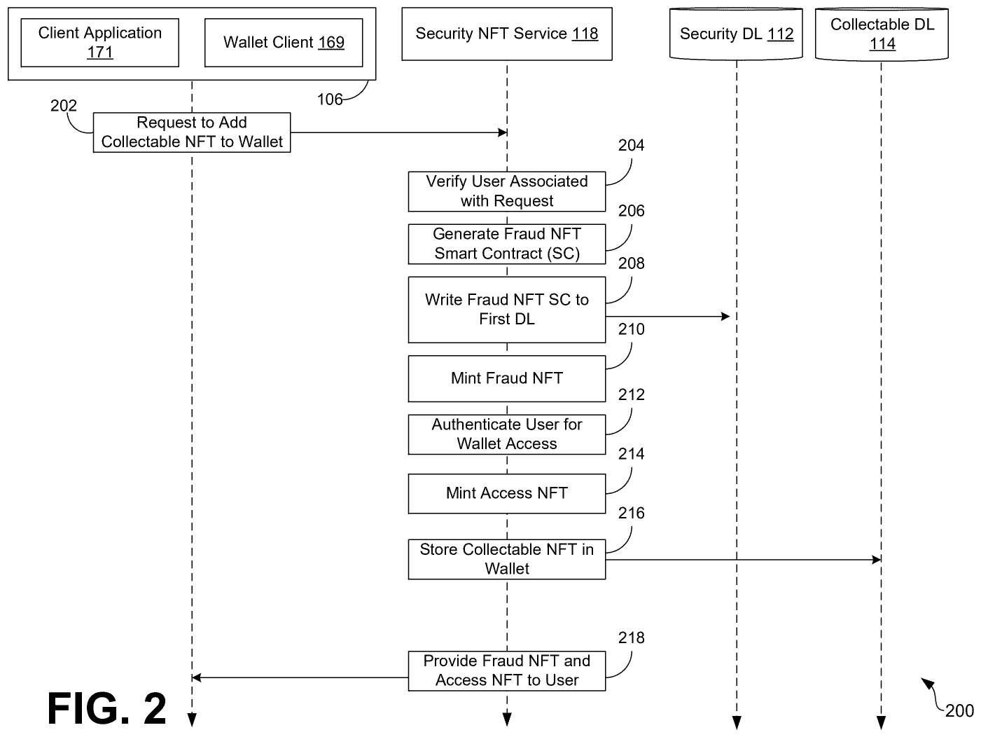

Next, a general description of the operation of the various components of the network environment 100 is provided with respect to FIGS. 2-4. To begin, FIG. 2 is a sequence diagram 200 depicting the interactions between the various components of the network environment 100 according to various embodiments of the present disclosure. The sequence diagram of FIG. 2 is intended to illustrate how the security NFT service 118 interacts with the other components of the network environment 100. As an alternative, the sequence diagram 200 of FIG. 2 can be viewed as depicting an example of elements of a method implemented within the network environment 100.

Beginning with block 202, a client application 171 can send a request to the security NFT service 118 requesting to add a collectable NFT 122 to the user wallet. In some examples, the request can include a collectable NFT identifier, a user wallet address 139, a collectable NFT smart contract wallet address 135, the wallet identifier 137, a public key 140 associated with the user wallet, and/or other type of information that is needed for the security NFT service 118 to add the collectable NFT 122 to the user wallet.

At block 204, the security NFT service 118 verifies the user associated with the request. In some examples, the security NFT service 118 verifies the user by executing the identity verification service 120. The identity verification service 120 can be executed to verify an identity of a user associated with a given user wallet address 139. For example, the identity verification service 120 can interact with a user associated with the user client device 106 and request documentation that can be used to verify the identity of the user. For example, the identity verification service 120 can request the user to provide a first image comprising a photograph of the user and a second image of a government issued identification card that includes a photograph of the user. The identity verification service 120 can compare the first image with the second image to verify whether the identity of the user is the same. In various examples, the identity verification service 120 verifies the identity of the user in accordance to identity verification standards (e.g., Know Your Customer (KYC), anti-money laundering (AML), etc.) to ensure the identity verification is compliant. In some examples, the identity verification service 120 can request one or more trusted third-party services that are executed outside of the security minting computing environment 102 to perform the identity verification of the user.

At block 206, the security NFT service 118 generates a fraud NFT smart contract 129. The fraud NFT smart contract 129 is generated to include executable code that can be stored on the security distributed ledger 112. In various examples, the fraud NFT smart contract 129 is generated in compliance with ERC-721, ERC-1125, or similar standards for implementing smart contracts for NFTs. In various examples, the fraud NFT smart contract 129 can check various conditions (e.g., ownership, wallet identifier, etc.) associated with the collectable NFT 122.

At block 208, the security NFT service 118 writes or otherwise publishes the fraud NFT smart contract 129 to the security distributed ledger 112. In various examples, once a transaction or record is recorded in the security distributed ledger 112, it can be replicated across the peer-to-peer network until the record is eventually recorded with all of the nodes. Various consensus methods can be used to ensure that data is written reliably to security distributed ledger 112.

At block 210, the security NFT service 118 mints the fraud NFT 124. In some examples, the security NFT service 118 can mint a fraud NFT 124 by invoking the mint function of the fraud NFT smart contract 129 stored in the security distributed ledger 112. The call to invoke the mint function can further include details about the user wallet as well as the collectable NFT 122. For example, the call can include, the collectable NFT identifier, the collectable NFT smart contract address 135, the wallet identifier, the user wallet address 139, the verification data 149, and/or other information. To link the fraud NFT 124 with the collectable NFT 122, the fraud NFT 124 can comprise a collectible NFT tuple 131 which can include a collectable NFT identifier 133 and a collectable NFT smart contract address 135 of the given collectable NFT 122. In addition, the security NFT service 118 can store the fraud NFT 124 in the user wallet by associating the fraud NFT 124 with a wallet identifier 137, user wallet address 139, and/or other type of wallet associator in the fraud NFT 124.

At block 212, the security NFT service 118 authenticates the user for access to the user wallet. For example, the user client device 106 associated with the requesting user can provide an authentication token or other form of authentication that can be validated. In other examples, the security NFT service 118 can authenticate the user by generating a cryptographic challenge and sending the cryptographic challenge to the user client device 106 associated with the user and the user wallet address 139. The user client device 106 can return the cryptographic challenge signed with the private key 142 associated with the user wallet address 139. In some examples, the user client device 106 obtains access to the private key 142 in response to the user providing a passcode to unlock the private key 142 for use in signing the cryptographic challenge. Upon receiving the signed cryptographic challenge and confirming that the public key 140 associated with the user wallet address 139 decrypts the signed cryptographic challenge, the security NFT service 118 can assert that the verified user controls the private key 142 associated with the user wallet address 139 and thereby controls the user wallet address 139.

At block 214, the security NFT service 118 mints the access NFT 126. In some examples, the security NFT service 118 generates an access NFT smart contract 141 which can be invoked to create or otherwise mint the access NFT 126. In various examples, the access NFT smart contract 141 is generated in compliance with ERC-721, ERC-1125, or similar standards for implementing smart contracts for NFTs. The security NFT service 118 can write the access NFT smart contract 141 to the security distributed ledger 112. The access NFT smart contract 141 can then be accessed via the access NFT smart contract address 153.

In some examples, the security NFT service 118 invokes a mint function associated with the access NFT smart contract 141 stored in the security distributed ledger 112. In various examples, the mint function call can include the user wallet address 139, wallet identifier 137, and/or other wallet specific data that can be used to associate the access NFT 126 with the NFT wallet of the user. In some examples, the access NFT 126 can further be created to include an access NFT identifier 143, access NFT permissions 147, verification data 149, and/or other data.

At block 216, the security NFT service 118 stores the collectable NFT 122 in the user wallet. For example, the security NFT service 118 can invoke a transfer function of the collectable NFT smart contract 185 stored in the collectable distributed ledger 114 to associate the collectable NFT 122 with the user wallet address 139 of the user wallet. In other examples, the security NFT service 118 can mint the collectable NFT 122 by invoking the mint function of the collectable NFT smart contract 185 to create the collectable NFT 122 in association with the user wallet address 139.

At block 218, the security NFT service 118 provides the fraud NFT 124 and the access NFT 126 to the client application 171 (or the wallet client 169). For example, the security NFT service 118 can provide the client application 171 (or the wallet client 169) with the fraud NFT smart contract address 130, the fraud NFT identifier 181, the access NFT smart contract address 153, the access NFT identifier 143, and/or other information. Thereafter, this portion of the process proceeds to completion.

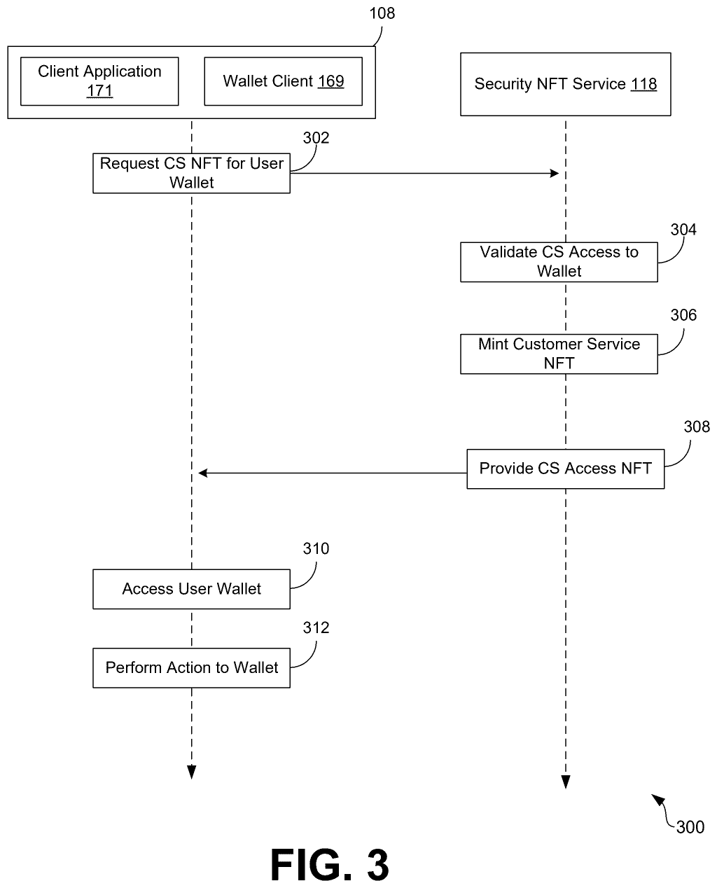

Turning now to FIG. 3, shown is a sequence diagram 300 depicting the interactions between the various components of the network environment 100 according to various embodiments of the present disclosure. The sequence diagram of FIG. 3 is intended to illustrate how the security NFT service 118 interacts with the other components of the network environment 100. As an alternative, the sequence diagram 300 of FIG. 3 can be viewed as depicting an example of elements of a method implemented within the network environment 100.

Beginning with block 302, the client application 171 (or wallet client 169) on the customer service client device 108 can generate and send a request to the security NFT service 118 for a customer service NFT 127 in association with a user wallet of a user. In various examples, the request can include the user wallet address 139 of the user wallet, a wallet identifier 137, an access NFT smart contract address 153, the access NFT identifier 143, and/or other information that could be required to generate the customer service NFT 127.

At block 304, the security NFT service 118 verifies that the user owning the user wallet permits the customer service client device 108 access to the user wallet. For example, the security NFT service 118 could interact with the user client device 106 of the user to obtain permission or verification that the customer service client device 108 is permitted to access the user wallet. In other examples, the security NFT service 118 can authenticate the user as well as authenticating the user permits the access by generating a cryptographic challenge and sending the cryptographic challenge to the user client device 106 associated with the user and the user wallet address 139. The user client device 106 can return the cryptographic challenge signed with the private key 142 associated with the user wallet address 139. In some examples, the user client device 106 obtains access to the private key 142 in response to the user providing a passcode to unlock the private key 142 for use in signing the cryptographic challenge. Upon receiving the signed cryptographic challenge and confirming that the public key 140 associated with the user wallet address 139 decrypts the signed cryptographic challenge, the security NFT service 118 can assert that the verified user controls the private key 142 associated with the user wallet address 139 and thereby controls the user wallet address 139. In other examples, the security NFT service 118 can request that the customer service client device 108 provide a token, the access NFT identifier 143 associated with the user wallet, and/or other type of verification token that can be used to verify that the customer service client device 108 is permitted access to the user wallet.

At block 306, the security NFT service 118 mints the customer service NFT 127 for the requesting device 108. For example, the security NFT service 118 can invoke a mint function associated with the customer service NFT smart contract 151 stored in the security distributed ledger 112. In various examples, the mint function call can include the user wallet address 139, wallet identifier 137 and/or other wallet specific data that can be used to associate the customer service NFT 127 with the NFT wallet of the user. Accordingly, the customer service NFT 127 can be generated to include the user wallet address 139, wallet identifier 137 and/or other wallet specific data that can be used to associate the customer service NFT 127 with the NFT wallet of the user. In some examples, the customer service NFT 127 can further be created to be associated with the access NFT 126 by including the access NFT smart contract address 153, the access NFT identifier 143, and/or other component that associates the customer service NFT 127 with the access NFT 126. The customer service NFT 127 can further include a customer service NFT identifier 155, customer service NFT permissions 159, and/or other data.

At block 308, the security NFT service 118 provides the customer service NFT 127 to the client application 171 (or the wallet client 169) of the customer service client device 108. For example, the security NFT service 118 can provide the client application 171 (or the wallet client 169) with the customer service NFT smart contract address 153, the customer service NFT identifier 155, and/or other information.

At block 310, the client application 171 (or the wallet client 169) of the customer service client device 108 accesses the user wallet using the customer service NFT 127. For example, a user could report fraud of a collectable NFT 122 associated with the user wallet and could request the customer service client device 108 to access the wallet via the wallet address 139 to review or detect other potential fraudulent transactions or activity associated with the user wallet. Accordingly, the customer service client device 108 can use the customer service NFT 127 to access the user wallet and review any areas of concern. In another example, the client application 171 (or the wallet client 169) of the customer service client device 108 can send a request to the quantum verification service 173 to review the fraud NFT smart contracts 129 for signs of fraud.

At block 312, the client application 171 (or the wallet client 169) of the customer service client device 108 can perform an action associated with the wallet. For example, upon detection of fraud, the client application 171 (or the wallet client 169) of the customer service client device 108 can lock the wallet and/or a particular stored collectable NFT 122. In this example, the client application 171 (or the wallet client 169) of the customer service client device 108 can add the wallet address 139 or the collectable NFT identifier 133 to the quantum NFT reports 177 in the quantum data store 175. Therefore, checks associated with the wallet address 139 and/or collectable NFT identifier 133 will result in a fraudulent detection thereby restricting access to the wallet address 139 and/or collectable NFT 122 for transactions or other uses. Thereafter, this portion of the process proceeds to completion.

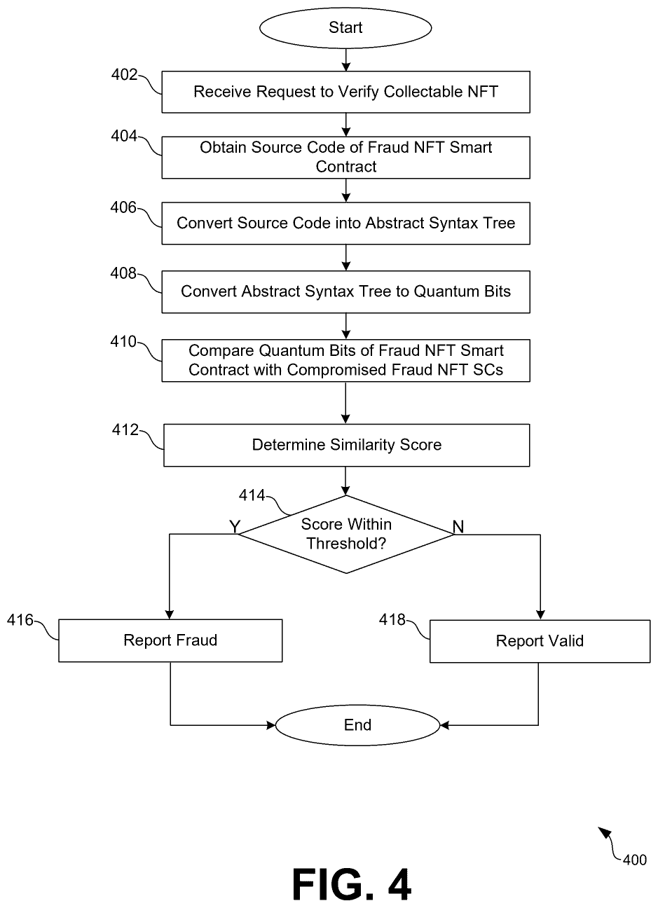

Referring next to FIG. 4, shown is a flowchart that provides one example of the operation of a portion of the quantum verification service 173. The flowchart of FIG. 4 provides merely an example of the many different types of functional arrangements that can be employed to implement the operation of the depicted portion of the quantum verification service 173. As an alternative, the flowchart of FIG. 4 can be viewed as depicting an example of elements of a method implemented within the network environment 100.

Beginning with block 402, the quantum verification service 173 receives a request to verify a collectable NFT 122. For example, a client application 171 or wallet 169 from a user client device 106 or a customer service client device 108 and/or other type of client device wanting to verify a collectable NFT 122 for a potential transaction, could send a request to the quantum verification service 173 to perform a check on the collectable NFT 122.

At block 404, the quantum verification service 173 obtains the source code of a fraud NFT smart contract 129. In some examples, the source code can be obtained by accessing the fraud NFT smart contract 129 via the fraud NFT smart contract address 130 which could be included in the request. In other examples, the fraud NFT smart contract 129 could be identified by performing a search in the security distributed ledger 112 for any fraud NFTs 124 associated with the collectable NFT identifier 133 of the collectable NFT 122.

At block 406, the quantum verification service 173 converts the source code to an abstract syntax tree based on the various conditions of the fraud NFT smart contract 129. For examples, the root of the abstract syntax tree can correspond to the declaration of the fraud NFT smart contract 129 and the corresponding edges and nodes that generate the abstract syntax tree can correspond to the different conditions that could be incorporated into the fraud NFT smart contract 129.

At block 408, the quantum verification service 173 can convert the abstract syntax tree representation into a quantum representation of bits. For example, the quantum verification service 173 can use a quantum conversion algorithm for converting the code into the quantum representation of bits.

At block 410, the quantum verification service 173 compares a quantum representation of a fraud NFT smart contract 129 with the compromised SC data 179 to determine the similarity between the different smart contracts. For example, the compromised smart contract data 179 can represent a quantum state representations of security NFT smart contracts associated with a compromised collectable NFTs 122 that have been reported as being compromised or otherwise fraudulent. For example, a fraud NFT smart contract 129 associated with a collectable NFT 122 that is determined to be compromised can be converted to an abstract tree representation which can then be converted to quantum bits for processing by a quantum computing device.

At block 412, the quantum verification service 173 determines a similarity score between the compromised fraud NFT smart contract 129 and the fraud NFT smart contract 129 of the collectable NFT 122. In some examples, the similarity score calculation can be done using quantum computing based at least in part on Grover's algorithm and Tree Edit Distance (TED).

At block 414, the quantum verification service 173 determines if the similarity score is within a given similarity threshold or range. If the similarity score is within a given similarity range, the quantum verification service 173 can determine that the collectable NFT 122 is compromised. For example, if the threshold range of similarity is between 95 and 100 and the similarity score that is 97, the collectable NFT 122 associated with the fraud NFT smart contract 129 will be determined to be compromised. If the similarity score is within the given range, the quantum verification service 173 will proceed to block 416. Otherwise, the quantum verification service 173 will proceed to block 420.

At block 416, the quantum verification service 173 determines that the collectable NFT 122 is fraudulent and reports the fraud. Accordingly, the quantum verification service 173 can add the collectable NFT 122 via the collectable NFT identifier 133 to the quantum NFT reports 177 to report the fraud. The quantum NFT reports 177 can include a listing of NFTs (e.g., collectable NFTs 122, fraud NFT 124, access NFT 126, customer service NFT 127, etc.) that have been reported as being compromised or otherwise fraudulent. In various examples, the quantum NFT reports 177 can be converted from a digital representation to a quantum representation for processing by a quantum computing device. Thereafter, this portion of the process proceeds to completion.

At block 418, the quantum verification service 173 reports that the collectable NFT 122 is valid. For example, the quantum verification service 173 can generate and send a notification to the requesting client device 106, 108 to indicate that the collectable NFT 122 is free of fraud. Accordingly, if the collectable NFT 122 is being assessed for a future transaction, the transacting party can be assured that the collectable NFT 122 is not compromised. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 102, 104.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
receive a request to store a collectable non-fungible token (NFT) in a user wallet associated with a user;
mint a security NFT, the security NFT being minted to be associated with the collectable NFT, and the security NFT being stored in a security distributed ledger; and
store the collectable NFT in the user wallet.

2. The system of claim 1, wherein the machine-readable instructions further cause the computing device to at least:
authenticate the user for access to the user wallet; and
mint a second security NFT to provide access to the user wallet in response to authenticating the user, the second security NFT being stored in the security distributed ledger.

3. The system of claim 1, wherein the security NFT comprises a fraud NFT, and wherein generating the security NFT comprises
generating a fraud NFT smart contract; and
invoking a mint function of the fraud NFT smart contract.

4. The system of claim 3, wherein the machine-readable instructions further cause the computing device to at least determine that the collectable NFT is compromised based at least in part on the fraud NFT.

5. The system of claim 4, wherein the machine-readable instructions further cause the computing device to at least:
determine a similarity score based at least in part on a comparison of source code of the fraud NFT smart contract with source code of a plurality of compromised fraud NFT smart contracts; and
the collectible NFT being determined to be compromised when the similarity score fails to meet or exceed a predefined threshold value.

6. The system of claim 1, wherein the request comprises a first request and the machine-readable instructions further cause the computing device to at least:
receive a second request from a customer service client device to access the user wallet associated with the user;
confirm that the customer service client device is permitted to access the user wallet; and
mint a customer service NFT to permit the customer service client device access to the user wallet, the customer service NFT being stored in the security distributed ledger.

7. The system of claim 6, wherein the customer service NFT provides time-restricted access to the user wallet.

8. The system of claim 1, wherein the machine-readable instructions further cause the computing device to at least verify an identity of the user.

9. The system of claim 8, wherein verifying the user comprises sending a service request to a trusted third-party service to verify an identity of the user.

10. A method, comprising:
receiving a request to verify a status of a collectable NFT;
obtaining source code associated with a security NFT smart contract associated with the collectable NFT;
generating a similarity score based at least in part on a comparison the source code associated with the security NFT smart contract with source code associated with a plurality of compromised security NFT smart contracts; and
determining that the collectable NFT is compromised based at least in part on the similarity score.

11. The method of claim 10, wherein the security NFT smart contract is associated with a security NFT, and in response to determining that the collectable NFT is compromised, adding a security NFT identifier of the security NFT to a quantum database.

12. The method of claim 11, wherein the security NFT comprises a collectable NFT identifier associated with the collectable NFT.

13. The method of claim 10, further comprising converting the source code associated with the security NFT smart contract into a first abstract syntax tree, and comparing the first abstract syntax tree with a respective second abstract syntax tree associated with individual compromised security NFT smart contracts of the plurality of compromised security NFT smart contracts.

14. The method of claim 13, wherein the similarity score is based at least in part on Grover's algorithm and Tree Edit Distance (TED).

15. A non-transitory, computer-readable medium, comprising machine-readable instructions that, when executed by a processor of a computing device, cause the computing device to at least:
receive a request to store a collectable non-fungible token (NFT) in a user wallet associated with a user;
mint a first security NFT, the first security NFT being generated to be associated with the collectable NFT and comprising a wallet identifier associated with the user wallet;
mint a second security NFT, the second security NFT being generated to provide access to the user wallet comprising the wallet identifier associated with the user wallet; and
store the first security NFT and the second security NFT in a private security distributed ledger.

16. The non-transitory, computer-readable medium of claim 15, wherein generating the first security NFT comprises:
generating a first security NFT smart contract; and
invoking a mint function of the first security NFT smart contract.

17. The non-transitory, computer-readable medium of claim 15, wherein the first security NFT further comprises a collectable NFT identifier associated with the collectable NFT and a collectable NFT smart contract address associated with the collectable NFT.

18. The non-transitory, computer-readable medium of claim 15, wherein the machine-readable instructions, when executed by the processor, further cause the computing device to at least verify an identity of the user, the first security NFT being generated in response to the identity of the user being identified.

19. The non-transitory, computer-readable medium of claim 15, wherein the machine-readable instructions, when executed by the processor, further cause the computing device to at least authenticate the user for access to the user wallet, the second security NFT being minted in response to the user being authenticated.

20. The non-transitory, computer-readable medium of claim 15, wherein the machine-readable instructions, when executed by the processor, further cause the computing device to at least store the collectable NFT in the user wallet.
